(19) United States
(12) Patent Application Publication
(10) Pub. No.: US 2021/0223660 A1
(43) Pub. Date: Jul. 22, 2021

(54) CONTROL METHOD, APPARATUS, DEVICE, SYSTEM AND STORAGE MEDIUM FOR MANUAL FOCUSING

(71) Applicant: SZ DJI TECHNOLOGY CO., LTD., Shenzhen (CN)

(72) Inventor: Tao ZHAO, Shenzhen (CN)

(21) Appl. No.: 17/224,440

(22) Filed: Apr. 7, 2021

Related U.S. Application Data
(63) Continuation of application No. PCT/CN2018/109690, filed on Oct. 10, 2018.

(51) Int. Cl. G03B 3/10; G03B 7/04; H04N 5/232

(52) U.S. Cl. CPC G03B 3/10; G03B 7/04; H04N 5/23216; H04N 5/23212; H04N 5/23293

(57) ABSTRACT

A photographing device includes a body, an optical assembly mounted at the body, a display assembly, a focus adjustment assembly, and a control apparatus including a memory storing program codes and a processor. The processor is configured to execute the program codes to, obtain a current adjustment position of the focus adjustment assembly, calculate a current focus value corresponding to the current adjustment position of the focus adjustment assembly according to the current adjustment position of the focus adjustment assembly, and, in response to the current focus value being equal to a focus parameter peak value and the adjustment position of the focus adjustment assembly continuing to change, control the focus adjustment assembly to stop focusing within a preset time period starting from a time at which the current focus value is equal to the focus parameter peak value.

### CROSS-REFERENCE TO RELATED APPLICATION

This application is a continuation of International Application No. PCT/CN2018/109690, filed Oct. 10, 2018, the entire content of which is incorporated herein by reference.

### TECHNICAL FIELD

The present disclosure relates to the field of cameras and, more particularly, to a control method, an apparatus, a device, a system, and a storage medium for manual focusing.

### BACKGROUND

Manual focus refers to manually adjusting a focus adjustment assembly (such as a focus ring) of a photographing device (such as a camera) to adjust an optical assembly (such as a lens) of the camera, to achieve a clear focusing. In digital cameras, manual focusing is still an indispensable function.

When a user focuses the camera manually, the user needs to slowly turn a focus ring of the camera. Further, in the process of turning the focus ring, the user needs to observe whether a focus object on the screen is clear through human eyes, and to stop turning the focus ring when the user observes that the focus object on the screen is clear enough. It is difficult for the user to accurately find a focus position when the focus object is in focus.

### SUMMARY

In accordance with the disclosure, there is provided a photographing device including a body, an optical assembly mounted at the body, a display assembly, a focus adjustment assembly, and a control apparatus including a memory storing program codes and a processor. The processor is configured to execute the program codes to, obtain a current adjustment position of the focus adjustment assembly, calculate a current focus value corresponding to the current adjustment position of the focus adjustment assembly according to the current adjustment position of the focus adjustment assembly, and, in response to the current focus value being equal to a focus parameter peak value and the adjustment position of the focus adjustment assembly continuing to change, control the focus adjustment assembly to stop focusing within a preset time period starting from a time at which the current focus value is equal to the focus parameter peak value.

Also in accordance with the disclosure, there is provided a control method including obtaining a current adjustment position of a focus adjustment assembly of a photographing device, calculating a current focus value corresponding to the current adjustment position of the focus adjustment assembly according to the current adjustment position of the focus adjustment assembly, and, in response to the current focus value being equal to a focus parameter peak value and the focus adjustment assembly continuing to change, controlling the focus adjustment assembly to stop focusing within a preset time period starting from a time at which the current focus value is equal to the focus parameter peak value.

### BRIEF DESCRIPTION OF THE DRAWINGS

The above and/or additional aspects and advantages of this disclosure will become obvious and easy to understand from the description of the embodiments in conjunction with the following drawings.

FIG. 1 is a flow chart of an exemplary control method for manual focusing consistent with various embodiments of the present disclosure.

FIG. 2 is schematic diagram of an exemplary photographing device consistent with various embodiments of the present disclosure.

FIG. 3 is a flow chart of another exemplary control method for manual focusing consistent with various embodiments of the present disclosure.

FIG. 4 is a schematic diagram of another exemplary photographing device consistent with various embodiments of the present disclosure.

FIG. 5 is a flow chart of another exemplary control method for manual focusing consistent with various embodiments of the present disclosure.

FIG. 6 is a schematic diagram of another exemplary photographing device consistent with various embodiments of the present disclosure.

FIG. 7 is a schematic diagram of another exemplary photographing device consistent with various embodiments of the present disclosure.

FIG. 8 is a flow chart of another exemplary control method for manual focusing consistent with various embodiments of the present disclosure.

FIG. 9 is a schematic diagram of another exemplary photographing device consistent with various embodiments of the present disclosure.

FIG. 10 is a schematic diagram of another exemplary photographing device consistent with various embodiments of the present disclosure.

FIG. 11 is a schematic structural diagram of an exemplary control apparatus consistent with various embodiments of the present disclosure.

FIG. 12 is a schematic structural diagram of another exemplary photographing device consistent with various embodiments of the present disclosure.

FIG. 13 is a schematic structural diagram of an exemplary photographing system consistent with various embodiments of the present disclosure.

### REFERENCE NUMERALS

20: photographing device 21: focus adjustment assembly 22: display assembly

23: focus object 24: focus object 25: focus object

26: focus object 27: focus object 28: icon

41: first indicator 42: second indicator 60: second indicator

61: first indicator 62: first indicator 63: first indicator 64: first indicator

110: control apparatus 111: memory 112: processor

120: photographing device 122: body 124: optical assembly

125: display assembly 126: focus adjustment assembly

128: control apparatus 121: communication interface

130: remote controller 132: antenna 134: focus adjustment assembly

136: control apparatus 138: display assembly

### DETAILED DESCRIPTION OF THE EMBODIMENTS

Technical solutions of the present disclosure will be described with reference to the drawings. It will be appreciated that the described embodiments are part rather than all of the embodiments of the present disclosure. Other embodiments conceived by those having ordinary skills in the art on the basis of the described embodiments without inventive efforts should fall within the scope of the present disclosure.

Example embodiments will be described with reference to the accompanying drawings, in which the same numbers refer to the same or similar elements unless otherwise specified.

As used herein, when a first assembly is referred to as “fixed to” a second assembly, it is intended that the first assembly may be directly attached to the second assembly or may be indirectly attached to the second assembly via another assembly. When a first assembly is referred to as “connecting” to a second assembly, it is intended that the first assembly may be directly connected to the second assembly or may be indirectly connected to the second assembly via a third assembly between them. The terms “perpendicular,” “horizontal,” “left,” “right,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

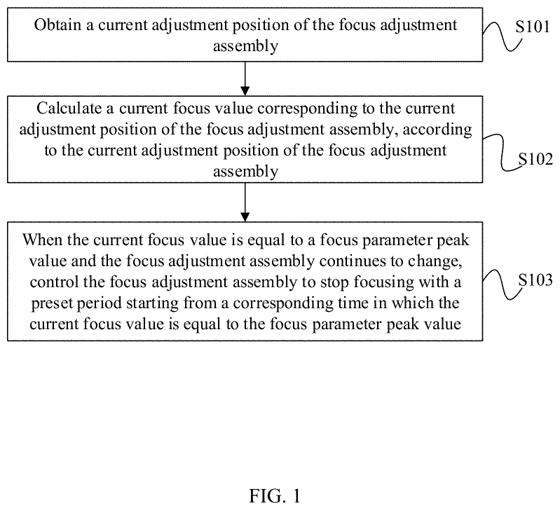

The present disclosure provides a control method for manual focusing. The control method of manual focusing may be applied to a photographing device. The photographing device may include a focus adjustment assembly. In one embodiment shown in FIG. 1, the control method for manual focusing includes S101 to S103.

At S101, a current adjustment position of the focus adjustment assembly is obtained.

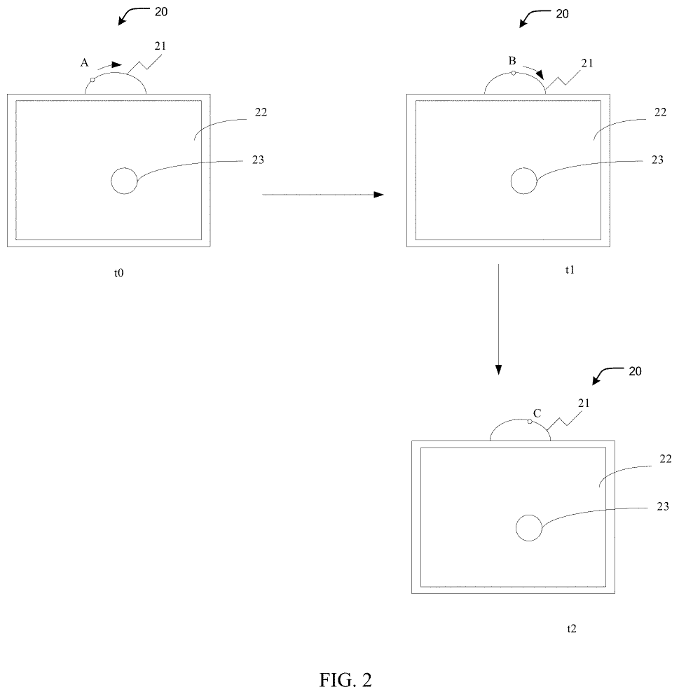

As shown in FIG. 2, the photographing device 20 may be a camera, a video camera, or another device with a photographing function such as a smart terminal. The photographing device 20 may be a handheld photographing device or a photographing device mounted at a movable platform such as an unmanned aerial vehicle. As shown in FIG. 2, the photographing device 20 includes a focus adjustment assembly 21. The focus adjustment assembly 21 is coupled with an optical assembly of the photographing device 20, and used to adjust a focus point of the optical assembly. In various embodiments, the focus adjustment assembly may include at least one of a focus ring, an adjustment button, or an adjustment wheel. For description purposes only, the embodiment with a focus ring will be used as an example for schematic description, and does not limit the scope of the present disclosure. When the user rotates the focus ring, the focus of the optical assembly will change with the rotation of the focus ring. As shown in FIG. 2, the user can rotate the focus ring in a clockwise direction, and can also rotate the focus ring in a counterclockwise direction. It can be understood that the focus ring can rotate within its rotation range, and when the focus ring rotates to a certain position at a certain moment, the position can be used as the adjustment position of the focus ring at that moment.

In one embodiment, the photographing device 20 may further include a control apparatus, and the control apparatus may be provided at a body of the photographing device 20, or the control apparatus may be a part of the body of the photographing device 20. In various embodiments, the control apparatus may be independent of the body or coupled with the body. The control apparatus may be electrically connected to the focus adjustment assembly 21, to obtain the current adjustment position of the focus adjustment assembly 21 in real time.

In some embodiments, the photographing device 20 may also be controlled by a remote controller. The remote controller may be a dedicated controller corresponding to the photographing device 20, or may be other terminal devices provided with control programs, such as smart phones, tablet computers, and the like. The remote controller and the photographing device 20 may perform wired communication or wireless communication. The remote controller may include a control apparatus that can receive the current adjustment position of the focus adjustment assembly 21 sent by the photographing device 20 in real time.

At S102, according to the current adjustment position of the focus adjustment assembly, a current focus value corresponding to the current adjustment position of the focus adjustment assembly is calculated.

When the focus adjustment assembly 21 adjusts the focus point of the optical assembly, the current focus value may change. For example, when the focusing ring is turned, the current focus value may change and the current focus value may indicate the turning position of the focus ring.

In some embodiments, the current focus value can be directly obtained according to the feedback of the focus adjustment assembly 21. In some other embodiments, the current focus value can also be calculated through a focus evaluation function. In some embodiments, the current focus value may be a value calculated using a focus evaluation function according to the image captured by current focus adjustment parameters. In some other embodiments, the current focus value may be associated with a variable of the focus evaluation function, or may be associated with a parameter corresponding to a variable of the focus evaluation function.

At S103, when the current focus value is equal to a focus parameter peak value and the adjustment position of the focus adjustment assembly 21 continues to change, the focus adjustment control assembly is controlled to stop focusing within a preset time period starting from a corresponding time at which the current focus value is equal to the focus parameter peak value.

As shown in FIG. 2, the photographing device 20 includes a display assembly 22 such as a display screen, and a focus object in a current image displayed by the display assembly 22 is denoted as 23.

In one embodiment, the photographing device 20 may capture image data through the optical assembly. The control apparatus of the photographing device 20 may calculate the focus parameter peak value when the focus object in the current image is in focus.

In another embodiment, the photographing device 20 may capture image data through the optical assembly and then send the image data to the remote controller. The control apparatus of the remote controller may calculate the focus parameter peak value when the focus object in the current image is in focus.

Specifically, the control apparatus may analyze the current image to obtain the focus evaluation function, and further calculate the focus parameter peak value when the focus object in the current image is in focus according to the focus evaluation function. The specific form of the focus evaluation function is not limited here, nor the specific method for determining the focus evaluation function. Optionally, the control apparatus may determine the focus evaluation function based on frequency domain analysis, information theory, or difference calculation.

As shown in FIG. 2, it is assumed that at time t0, the adjustment position of the focus adjustment assembly 21 is at position A. At this time, the current focus value corresponding to the current adjustment position of the focus adjustment assembly is not equal to the focus parameter peak value, and the optical assembly is not fully focused on the focus object. The focus object is not clear enough in the photographed picture. The user continues to adjust the focus adjustment assembly 21, for example, to adjust the focus adjustment assembly 21 in a clockwise direction. At time t1, the adjustment position of the focus adjustment assembly 21 is at position B. It is assumed that at this time, the current focus value corresponding to the adjustment position of the focus adjustment assembly 21 is equal to the focus parameter peak value, the optical assembly of the photographing device 20 is fully focused on the focus object, and the focus object is clearly visible in the photographed image. Position B can be used as the focus position when the focus object is in focus. However, the user may feel that the focus object is not clear enough in the photographed image at this time, and hope that the focus object can be clearer in the photographed image. The user may continue to adjust the focus adjustment assembly 21, for example, continue to adjust the focus adjustment assembly 21 in a clockwise direction. 21. At time t2, the adjustment position of the focus adjustment assembly 21 is at position C.

In one embodiment, when the control apparatus determines that the current focus value is equal to the focus parameter peak value at time t1, the control apparatus may determine that the adjustment position of the focus adjustment assembly continues to change according to the real time adjustment position of the focus adjustment assembly after time t1. For example, from time t1 to time t2, the adjustment position of the focus adjustment assembly 21 may constantly change. Correspondingly, the control apparatus may control the focus adjustment assembly to stop focusing in the preset time period starting from the corresponding time at which the current focus value is equal to the focus parameter peak value (that is, time t1). That is, the current focus value is equal to the focus parameter peak value at time t1, and the adjustment position of the focus adjustment assembly continues to change after time t1. Time t2 is in the preset time period starting from time t1. Correspondingly, in the time period from time t1 to time t2, the control apparatus controls the focus adjustment assembly 21 to stop focusing. From time t1 to time t2, although the user is still adjusting the focus adjustment assembly 21, the focus adjustment assembly 21 stops focusing, that is, the focus adjustment assembly 21 stops adjusting the focus of the optical assembly and the current focus value is kept equal to the focus parameter peak value, such that the focus object is clearly visible in the photographed image.

In the present disclosure, the current adjustment position of the focus adjustment assembly may be obtained, and the current focus value corresponding to the current adjustment position of the focus adjustment assembly may be calculated according to the current adjustment position of the focus adjustment assembly. When the current focus value is equal to the focus parameter peak value, the adjustment position of the focus adjustment assembly may be obtained continuously to determine whether the adjustment position of the focus adjustment assembly continues to change. When it is determined that the adjustment position of the focus adjustment assembly continues to change after the current focus value is equal to the focus parameter peak value, the focus adjustment assembly may be controlled to stop focusing within the preset time period starting from the time at which the current focus value is equal to the focus parameter peak value. That is, although the user may still adjust the focus adjustment assembly within the preset time period, the focus adjustment assembly may have stopped focusing, and the focus adjustment assembly may have stopped adjusting the focus of the optical assembly, to keep the current focus value equal to the focus parameter peak value and the focus object clearly visible in the photographed image. The problem that it is difficult for the user to find the focus position when the focus object is in focus induced by continuous adjustment of the focus adjustment assembly by the user after the current focus value is equal to the focus parameter peak value may be avoided.

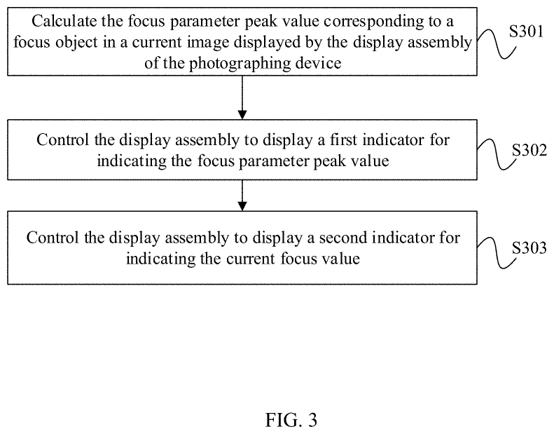

The present disclosure also provides another control method for manual focusing. As shown in FIG. 3, based on the control method shown in FIG. 1, in one embodiment, the control method further includes S301 to S303.

At S301, the focus parameter peak value corresponding to a focus object in a current image displayed in the display assembly of the photographing device is calculated.

Specifically, the control apparatus may calculate the focus parameter peak value corresponding to the focus object in the current image displayed in the display assembly of the photographing device when the focus object is in focus.

At S302, the display assembly is controlled to display a first indicator. The first indicator is configured to indicate the focus parameter peak value.

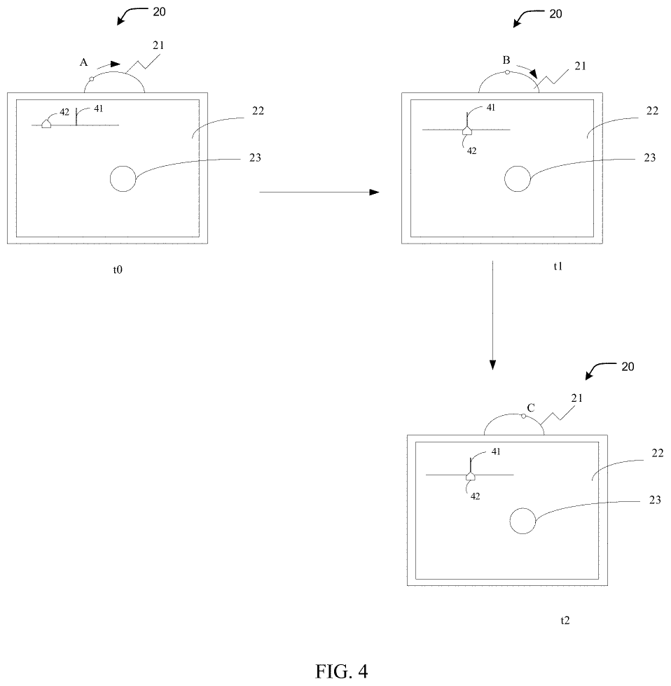

As shown in FIG. 4, when the control apparatus calculates the focus parameter peak value when the focus object is in focus, the display assembly 22 is controlled to display the first indicator 41. The first indicator 41 is configured to indicate the focus parameter peak value. For description purposes only, the embodiment in FIG. 4 is used as an example to illustrate the present disclosure and does not limit the shape of the first indicator in the present disclosure.

At S303, the display assembly is controlled to display a second indicator. The second indicator is configured to indicate the current focus value.

The control apparatus is further configured to control the display assembly 22 to display the second indicator 42. For description purposes only, the embodiment in FIG. 4 is used as an example to illustrate the present disclosure and does not limit the shape of the second indicator in the present disclosure.

The second indicator 42 is configured to indicate the current focus value corresponding to the current adjustment position of the focus adjustment assembly 21. An indicator distance between the first indicator and the second indicator is associated with a difference between the focus parameter peak value and the current focus value.

As shown in FIG. 4, at time t0, the adjustment position of the focus adjustment assembly 21 is at position A, and the current focus value is smaller than the focus parameter peak value. Correspondingly, the second indicator 42 is located at the left side of the first indicator 41. When the distance between the first indicator 41 and the second indicator 42 is larger, the difference between the focus parameter peak value and the current focus value is larger.

Optionally, in one embodiment, when the current focus value is equal to the focus parameter peak value, the first indicator and the second indicator may overlap. For example, at time t1, the adjustment position of the focus adjustment assembly 21 is at position B, and the current focus value is equal to the focus parameter peak value. Correspondingly, the second indicator 42 and the first indicator 41 overlap.

Optionally, in one embodiment, within the preset time period, the first indicator and the second indicator may overlap in a user interface displayed by the display assembly. For example, at time t1, the current focus value is equal to the focus parameter peak value, and the adjustment position of the focus adjustment assembly continues to change after time t1. Time t2 is within the preset time period from time t1. Correspondingly, in the time period from time t1 to time t2, the control apparatus controls the focus adjustment assembly 21 to stop focusing. That is, from time t1 to time t2, although the user is still adjusting the focus adjustment assembly 21, the focus adjustment assembly 21 has stopped focusing, and has stopped adjusting the focus of the optical assembly to keep the current focus value equal to the focus parameter peak value. Correspondingly, the second indicator 42 and the first indicator 41 remain overlapping from time t1 to time t2.

In the present disclosure, the display assembly may be controlled to display the first indicator for indicating the focus parameter peal value and the second indicator for indicating the current focus value. When the first indicator and the second indicator do not overlap, the user may be prompted to adjust the focus adjustment assembly to make the first indicator and the second indicator overlap and make the focus parameter peak value be equal to the current focus value. Correspondingly, the photographing device may be able to focus on the focus object quickly and accurately, and the user can find the focus position when the focus object is in focus quickly and accurately in the manual focusing.

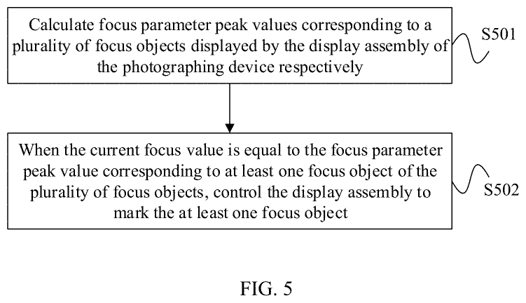

Another embodiment of the present disclosure provides another control method for manual focusing. As shown in FIG. 5, based on the embodiment in FIG. 1, the control method in the present embodiment further includes S501 and S502.

At S501, focus parameter peak values respectively corresponding to a plurality of focus objects in the current image displayed by the display assembly of the photographing device are calculated.

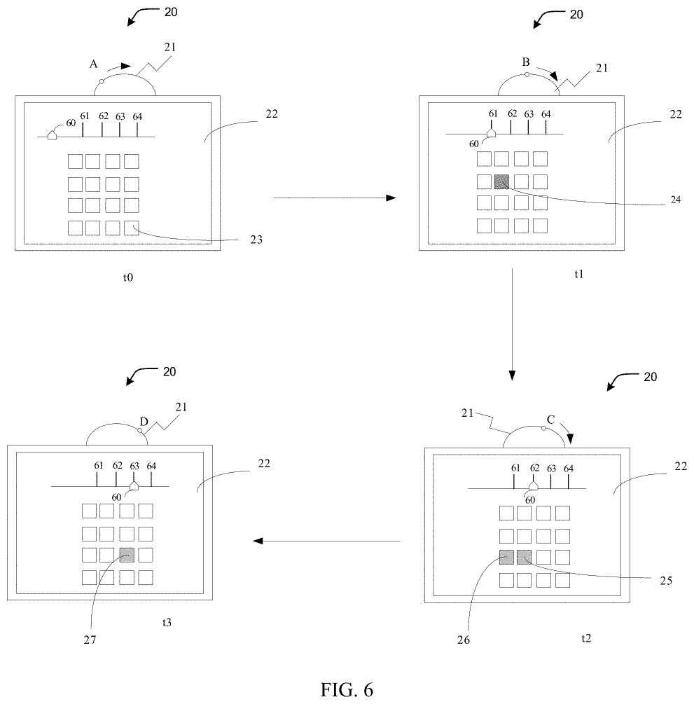

As shown in FIG. 6, the current image displayed by the display assembly 22 includes the plurality of focus objects. For example, the focus object 23 may be one of the plurality of focus objects. The control apparatus may calculate a focus parameter peak value of each focus object of the plurality of focus objects when the focus object is in focus. The focus parameter peak value of each focus object of the plurality of focus objects may be different, or may be partially same. That is, each focus object of the plurality of focus objects may correspond to a different focus parameter peak value, or a portion of the plurality of focus objects may correspond to a same focus parameter peak value.

Optionally, in one embodiment, the control method may further include: controlling the display assembly to display a plurality of first indicators configured to indicate the focus parameter peaks corresponding to the plurality of focus objects respectively; and controlling the display assembly to display the second indicator configured to indicate the current focus value. An indicator distance between each first indicator of the plurality of first indicators and the second indicator is associated with a difference between the focus parameter peak value of the first indicator and the current focus value.

As shown in FIG. 6, after the control apparatus calculates the focus parameter peak value of each focus object of the plurality of focus objects when the focus object is in focus, the control apparatus controls the display assembly 22 to display the plurality of first indicators. Specifically, in one embodiment, the plurality of first indicators includes a first indicator 61, a first indicator 62, a first indicator 63, and a first indicator 64. The first indicator 61, the first indicator 62, the first indicator 63, and the first indicator 64 are configured to indicate the focus parameter values when at least one focus object of the plurality of focus objects is in focus. The control apparatus is further configured to control the display assembly 22 to display the second indicator 60. The second indicator 60 is configured to indicate the current focus value corresponding to the current adjustment position of the focus adjustment assembly 21. An indicator distance between one first indicator of the plurality of first indicators (for example, the first indicator 61) and the second indicator is associated with a difference between the focus parameter peak value of the first indicator (for example, the first indicator 61) and the current focus value.

As shown in FIG. 6, at time t0, the adjustment position of the focus adjustment assembly 21 is at position A, and the current focus value is smaller than the focus parameter peak value. Correspondingly, the second indicator 62 is located at the left side of the first indicator 61. When the distance between the first indicator 61 and the second indicator 62 is larger, the difference between the focus parameter peak value of the first indicator 61 and the current focus value is larger.

Optionally, in one embodiment, when the current focus value is equal to the focus parameter peak value, the first indicator corresponding to the focus parameter peak value and the second indicator may overlap.

For example, at time t1, the adjustment position of the focus adjustment assembly 21 is at position B, and the current focus value is equal to the focus parameter peak value corresponding to the first indicator 61. Correspondingly, the second indicator 62 and the first indicator 61 overlap.

At S502, when the current focus value is equal to the focus parameter peak value corresponding to at least one focus object of the plurality of focus objects, the display assembly is controlled to mark the at least one focus object.

For example, the first indicator 61 indicates the focus parameter peak value of the focus object 24 when the focus object 24 is in focus. At time t1, the current focus value is equal to the peak value of the focus parameter corresponding to the first indicator 61. At this time, the control apparatus controls the display assembly to mark the focus object 24. For example, the display assembly may be controlled to display the focus object 24 in a highlight manner or identify the focus object 24 in a striking color, such as a red frame.

For another example, the first indicator 62 indicates the focus parameter peak value when the focus object 25 and the focus object 26 are in focus. At time t2, the adjustment position of the focus adjustment assembly 21 is at position C. At this time, the current focus value is equal to the focus parameter peal value corresponding to the first indicator 62. Correspondingly, the second indicator 60 and the first indicator 62 overlap, and the control apparatus controls the display assembly to mark the focus object 25 and the focus object 26.

For another example, the first indicator 63 indicates the focus parameter peak value when the focus object 27 is in focus. At time t3, the adjustment position of the focus adjustment assembly 21 is at position D. At this time, the current focus value is equal to the focus parameter peal value corresponding to the first indicator 63. Correspondingly, the second indicator 60 and the first indicator 63 overlap, and the control apparatus controls the display assembly to mark the focus object 27.

In the present embodiment, when the control apparatus determines that the current focus value is equal to the focus parameter peak value corresponding to one of the plurality of first indicators, the control apparatus may be configured to determine whether the adjustment position of the focus adjustment assembly continues to change. When it is determined that the adjustment position of the focus adjustment assembly continues to change, the control apparatus may be configured to control the focus adjustment assembly to stop focusing within the preset time period starting from the corresponding time at which the current focus value is equal to the focus parameter peak value corresponding to the one of the plurality of first indicators.

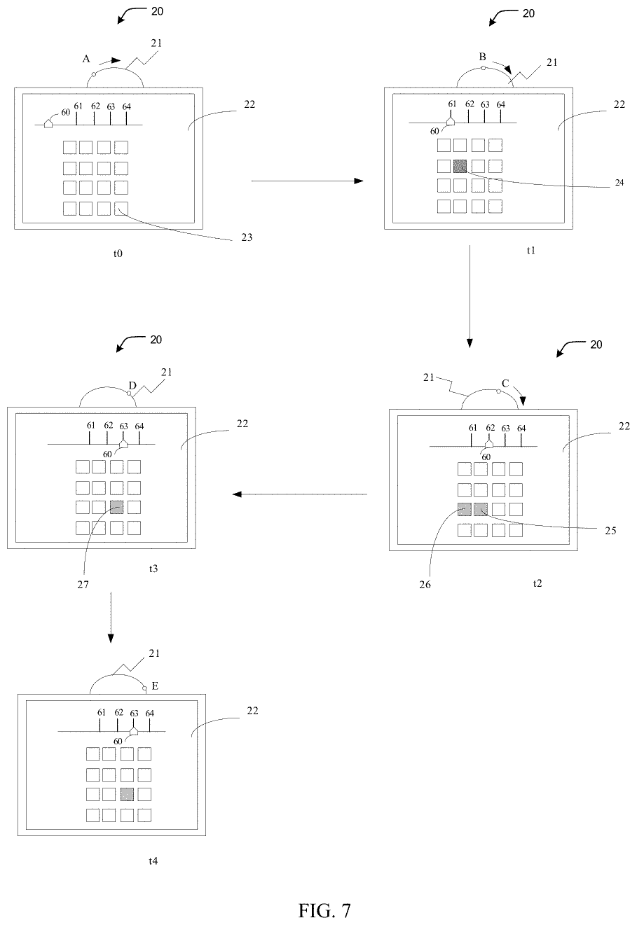

As shown in FIG. 7, at time t3, the adjustment position of the focus adjustment assembly 21 is at position D. At this time, the current focus value is equal to the focus parameter peal value corresponding to the first indicator 63. Correspondingly, the second indicator 60 and the first indicator 63 overlap. When it is determined that the adjustment position of the focus adjustment assembly continues to change, for example, the adjustment position of the focus adjustment assembly 21 is at position E at time t4 and time t4 is in the preset time period starting from time t3. Correspondingly, the control apparatus controls the focus adjustment assembly to stop focusing within the preset time period from t3 to t4, to keep the second indicator 60 and the first indicator 63 overlap.

In the present embodiment, the focus parameter peak values respectively corresponding to the plurality of focus objects in the current image displayed by the display assembly of the photographing device may be calculated. When the current focus value is equal to the focus parameter peak value corresponding to at least one focus object of the plurality of focus objects, the display assembly may be controlled to mark the at least one focus object, to prompt the user that the optical assembly of the photographing device is completely focused at the marked at least one focus object. Focusing on the plurality of focus objects may be achieved.

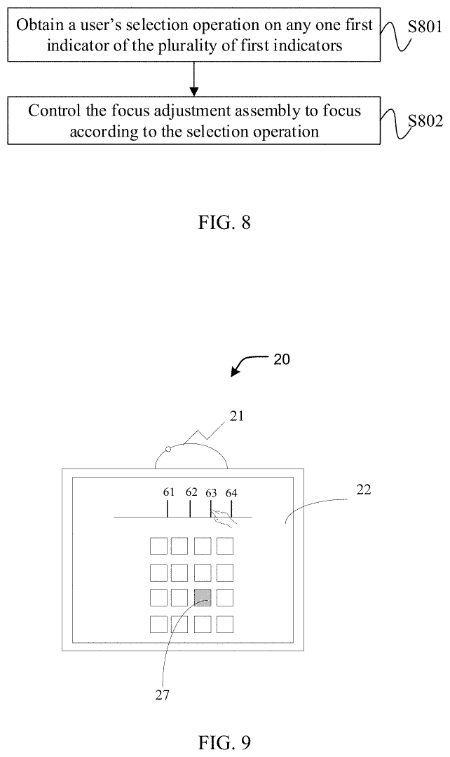

The present disclosure also provides another control method for manual focusing. As illustrated in FIG. 8, based on the above embodiments, the control method further includes S801 to S802.

At S801, a user's selection operation on any one first indicator of the plurality of first indicators is obtained.

As shown in FIG. 9, the display assembly 22 displays the plurality of first indicators. For example, the plurality of first indicators in FIG. 9 includes the first indicator 61, the first indicator 62, the first indicator 63, and the first indicator 64. The first indicator 61, the first indicator 62, the first indicator 63, and the first indicator 64 are configured to indicate the focus parameter peak value when at least one focus object of the plurality of focus objects is in focus. The user can select any one first indicator of the plurality of first indicators and the control apparatus is configured to obtain the user's selection operation on any one first indicator of the plurality of first indicators.

Optionally, in one embodiment, obtaining the user's selection operation on any one first indicator of the plurality of first indicators may be achieved in the following manners.

One manner to achieve obtaining the user's selection operation on any one first indicator of the plurality of first indicators may be obtaining a user's click operation on any one first indicator of the plurality of first indicators.

As shown in FIG. 9, the user clicks the first indicator 63 on the display assembly 22. The display assembly 22 may be a touch control screen, and may be able to sense the user's click operation on the first indicator 63 and send the click operation to the control apparatus.

Another manner to achieve obtaining the user's selection operation on any one first indicator of the plurality of first indicators may be obtaining a user's operation on a selection button. The selection button is used to select any one first indicator of the plurality of first indicators.

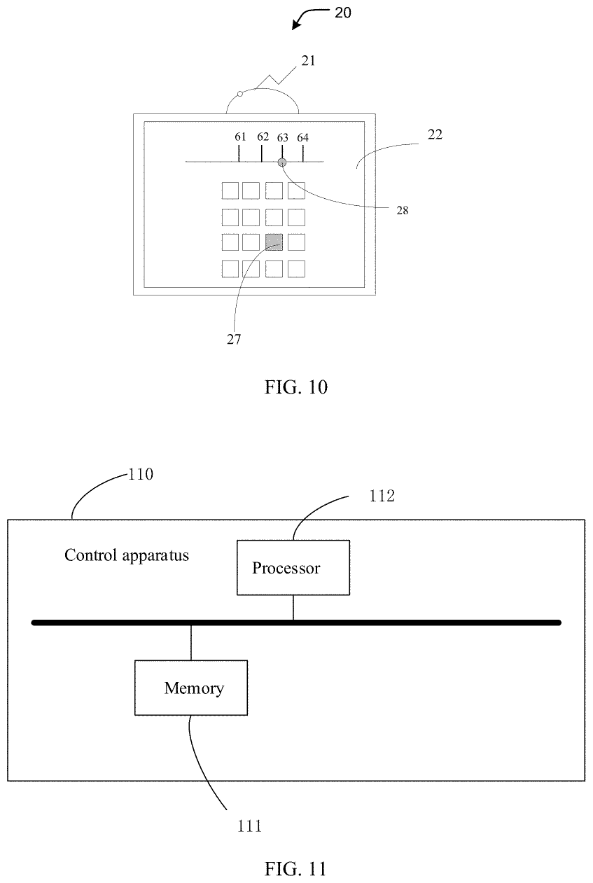

As shown in FIG. 10, the photographing device 20 is also provided with a selection button. The selection button may be a physical button provided at the body of the photographing device 20 or a virtual button displayed on the display assembly 22. When the user operates the selection button, an icon 28 corresponding to the selection button moves on the display assembly 22 such that the icon 28 can overlap with any one first indicator of the plurality of first indicators. When the icon 28 overlaps with a certain first indicator of the plurality of first indicators, for example, the first indicator 63, it means that the user has selected the first indicator 63.

At S802, the focus adjustment assembly is controlled to focus according to the selection operation.

According to the user's selection operation on any one first indicator of the plurality of first indicators, the control apparatus may control the focus adjustment assembly 21 to perform focus on a focus object corresponding to one first indicator of the plurality of first indicators selected by the user. For example, the first indicator 63 is configured to indicate the focus parameter peak value when the focus object 27 is in focus. When the user selects the first indicator 63, the control apparatus controls the focus adjustment assembly 21 to perform focus on the focus object 27.

In some embodiments, the control method may further include: controlling the display assembly to mark at least one focus object of the plurality of focus objects corresponding to the first indicator selected by the user.

As shown in FIG. 10, the first indicator 63 is configured to indicate the focus parameter peak value when the focus object 27 is in focus. When the user selects the first indicator 63, the control apparatus is further configured to control the display assembly 22 to mark the focus object 27. For example, the display assembly may display the focus object 27 in a highlight manner, or identify the focus object 27 in a striking color, such as a red frame.

In the present embodiment, the display assembly may be controlled to display the plurality of first indicators indicating the plurality of focus parameter peak values, and obtain the user's selection operation on any one first indicator of the plurality of first indicators. According to the user's selection operation on any one first indicator of the plurality of first indicators, the focus adjustment assembly may be controlled to perform focus on a focus object corresponding to one first indicator of the plurality of first indicators selected by the user. The flexibility of focusing on each of the plurality of focus objects may be improved.

The present disclosure also provides a control apparatus. FIG. 11 shows an exemplary control apparatus 110 provided by an embodiment of the present disclosure. As shown in FIG. 11, the control apparatus 110 includes a memory 111 and a processor 112. The memory 111 is configured to store program codes, and the processor 112 is configured to execute the program codes. When the program codes are executed the processor is configured to achieve operations including: obtaining a current adjustment position of a focus adjustment assembly for manual adjustment; calculating a current focus value corresponding to the current adjustment position of the focus adjustment assembly, according to the current adjustment position of the focus adjustment assembly; and when the current focus value is equal to a focus parameter peak value and the adjustment position of the focus adjustment assembly continues to change, controlling the focus adjustment assembly to stop focusing with a preset time period starting from a time at which the current focus value is equal to the focus parameter peak value.

Optionally, the processor 112 may be further configured to: calculate the focus parameter peak value corresponding to a focus object in a current image displayed by the display assembly of the photographing device; control the display assembly to display a first indicator for indicating the focus parameter peak value; and control the display assembly to display a second indicator for indicating the current focus value. An indicator distance between the first indicator and the second indicator is associated with a difference between the focus parameter peak value and the current focus value.

Optionally, when the current focus value is equal to the focus parameter peak value, the first indicator and the second indicator may overlap.

Optionally, with the preset time period, the first indicator and the second indicator may overlap in a user interface displayed by the display assembly.

Optionally, the processor 112 may be further configured to: calculate focus parameter peak values corresponding to a plurality of focus objects displayed by the display assembly of the photographing device respectively; and when the current focus value is equal to the focus parameter peak value corresponding to at least one focus object of the plurality of focus objects, control the display assembly to mark the at least one focus object.

Optionally, the processor 112 may be further configured to: control the display assembly to display a plurality of first indicators configured to indicate the focus parameter peak values corresponding to the plurality of focus objects respectively; and control the display assembly to display the second indicator configured to indicate the current focus value. An indicator distance between each first indicator of the plurality of first indicators and the second indicator is associated with a difference between the focus parameter peak value of the first indicator and the current focus value.

Optionally, when the current focus value is equal to the focus parameter peak value corresponding to one first indicator of the plurality of first indicators, the one first indicator and the second indicator may overlap.

Optionally, the processor 112 may be further configured to: obtain a user's selection operation on any one first indicator of the plurality of first indicators, and control the focus adjustment assembly to focus according to the selection operation.

Optionally, when the processor 112 is configured to obtain a user's selection operation on any one first indicator of the plurality of first indicators, the processor 112 may be configured to specifically obtain a user's click operation on any one first indicator of the plurality of first indicators.

Optionally, when the processor 112 is configured to obtain a user's selection operation on any one first indicator of the plurality of first indicators, the processor 112 may be configured to specifically obtain a user's operation on a selection button. The selection button is used to select any one first indicator of the plurality of first indicators.

Optionally, the processor 112 may be further configured to control the display assembly to mark at least one focus object of the plurality of focus objects corresponding to the one first indicator selected by the user.

Optionally, the focus adjustment assembly may include at least one of a focus ring, an adjustment button, or an adjustment wheel.

The operation principle and implementation of the control apparatus are similar to those of the above embodiments, and will not be repeated here.

In the present disclosure, the current adjustment position of the focus adjustment assembly may be obtained, and the current focus value corresponding to the current adjustment position of the focus adjustment assembly may be calculated according to the current adjustment position of the focus adjustment assembly. When the current focus value is equal to the focus parameter peak value, the adjustment position of the focus adjustment assembly may be continued to be obtained to determine whether the adjustment position of the focus adjustment assembly continues to change. When it is determined that the adjustment position of the focus adjustment assembly continues to change after the current focus value is equal to the focus parameter peak value, the focus adjustment assembly may be controlled to stop focusing within a preset time period starting from the time at which the current focus value is equal to the focus parameter peak value. That is, although the user may still adjust the focus adjustment assembly within the preset time period, the focus adjustment assembly may have stopped focusing, and the focus adjustment assembly may have stopped adjusting the focus of the optical assembly, keeping the current focus value equal to the focus parameter peak value and the focus object clearly visible in the photographed image. The problem that it is difficult for the user to find the focus position when the focus object is in focus induced by continuous adjustment of the focus adjustment assembly by the user after the current focus value is equal to the focus parameter peak value may be avoided.

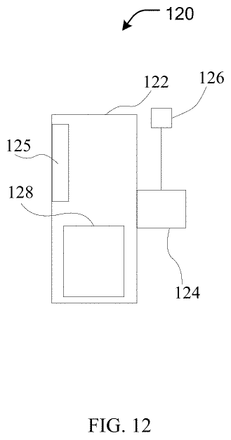

The present disclosure also provides a photographing device. As shown in FIG. 12, in one embodiment, a photographing device 120 includes a body 122, an optical assembly 124 mounted at the body 122 for capturing image information, a display assembly 125 for displaying the image information, a focus adjustment assembly 126 connected to the optical assembly 124 for adjusting a focus point of the optical assembly 124, and a control apparatus 128. The operation principle and implementation of the control apparatus are similar to those of the above embodiments, and will not be repeated here.

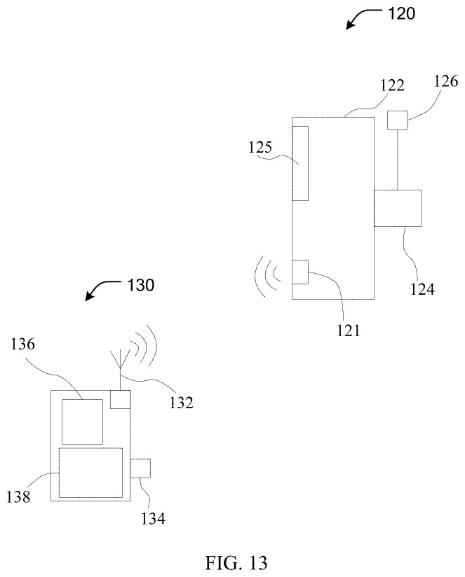

The present disclosure also provides a photographing system. In one embodiment shown in FIG. 13, the photographing system includes a remote controller 130 and a photographing device 120. The photographing device 120 includes a communication interface 121, a body 122, an optical assembly 124, a display assembly 125, and a focus adjustment assembly 126. The remote controller 130 includes a body, an antenna 132 mounted at the body for communication with the photographing device, a focus adjustment assembly 134 mounted at the body for adjusting a focus point of the optical assembly 124, and a control apparatus 136. For example, in one embodiment, the antenna 132 may be configured to communicate with the communication interface 121 of the photographing device 120 in a wireless manner. The operation principle and implementation of the control apparatus are similar to those of the above embodiments, and will not be repeated here. A user may adjust the focus adjustment assembly 134 and the focus adjustment assembly 134 may trigger the remote controller 130 to send an adjustment signal to the photographing device 120. The adjustment signal may instruct a motor mounted at the optical assembly 134 or the body 122 to rotate to drive the optical assembly 124 to focus. In one embodiment, the remote controller 130 may further include a display assembly 138 for displaying the image information photographed by the photographing device 120.

The present disclosure also provides a computer-readable storage medium. The computer-readable storage medium is configured to store a computer program, and the computer program is configured to be executed by a processor to implement the manual focus control method provided by various embodiments of the present disclosure.

In the embodiments provided by the present disclosure, it should be understood that the disclosed device and method can be implemented in other ways. For example, the device embodiments described above are merely illustrative. The division of the units is only a logical function division, and there may be other divisions in actual implementation, for example, multiple units or components may be combined or can be integrated into another system, or some features can be ignored or not implemented. Further, the shown or discussed mutual coupling or direct coupling or communication connection may be indirect coupling or communication connection through some interfaces, devices or units, and may be in electrical, mechanical or other forms.

The units described as separate components may or may not be physically separated, and the components shown as units may or may not be physical units, that is, they may be located in one place, or they may be distributed on multiple network units. Some or all of the units may be selected according to actual needs to achieve the objectives of the solutions of the embodiments. In addition, the functional units in the various embodiments of the present disclosure may be integrated into one processing unit, or each unit may exist alone physically, or two or more units may be integrated into one unit.

The above-mentioned integrated unit may be implemented in the form of hardware, or may be implemented in the form of hardware plus software functional units. The above-mentioned integrated unit implemented in the form of a software functional unit may be stored in a computer readable storage medium. The above-mentioned software functional unit is stored in a storage medium and includes several instructions to make a computer device (which may be a personal computer, a server, or a network device, etc.) or a processor execute part of the steps the method described in the various embodiments of the present disclosure. The aforementioned storage medium may include: a flash disk, a mobile hard disk, a read-only memory (ROM), a random access memory (RAM), a magnetic disk, an optical disk, or another medium that can store program code.

In this disclosure, terms such as “first” and “second” are only used to distinguish one entity or operation from another entity or operation, and do not necessarily require or imply existence of any such relationship or sequence among these entities or operations. The terms “include,” “comprise” or any other variants thereof are intended to cover non-exclusive inclusion, so that a process, method, article, or device including a series of elements not only includes those elements, but also includes other elements not explicitly listed, or also includes elements inherent to such process, method, article, or device. If there are no more restrictions, the element associated with “including a . . . ” does not exclude the existence of other identical elements in the process, method, article, or device that includes the element.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A photographing device comprising:
a body;
an optical assembly mounted at the body and configured to capture image information;
a display assembly configured to display the image information;
a focus adjustment assembly; and
a control apparatus including:
a memory storing program codes; and
a processor is configured to execute the program codes to:
obtain a current adjustment position of the focus adjustment assembly;
calculate a current focus value corresponding to the current adjustment position of the focus adjustment assembly according to the current adjustment position of the focus adjustment assembly; and
in response to the current focus value being equal to a focus parameter peak value and the adjustment position of the focus adjustment assembly continuing to change, control the focus adjustment assembly to stop focusing within a preset time period starting from a time at which the current focus value is equal to the focus parameter peak value.

2. The photographing device according to claim 1, wherein the processor is further configured to execute the program codes to:
calculate the focus parameter peak value corresponding to a focus object in a current image displayed by the display assembly;
control the display assembly to display a first indicator indicating the focus parameter peak value; and
control the display assembly to display a second indicator indicating the current focus value, an indicator distance between the first indicator and the second indicator being associated with a difference between the focus parameter peak value and the current focus value.

3. The photographing device according to claim 2, wherein, when the current focus value is equal to the focus parameter peak value, the first indicator and the second indicator overlap with each other.

4. The photographing device according to claim 3, wherein the first indicator and the second indicator overlap with each other in a user interface displayed by the display assembly within the preset time period.

5. The photographing device according to claim 1, wherein the processor is further configured to execute the program codes to:
calculate focus parameter peak values corresponding to a plurality of focus objects, respectively, in a current image displayed by the display assembly; and
in response to the current focus value being equal to the focus parameter peak value corresponding to at least one focus object of the plurality of focus objects, control the display assembly to mark the at least one focus object.

6. The photographing device according to claim 5, wherein the processor is further configured to execute the program codes to:
control the display assembly to display a plurality of first indicators indicating the focus parameter peak values corresponding to the plurality of focus objects, respectively; and
control the display assembly to display a second indicator indicating the current focus value, an indicator distance between one first indicator of the plurality of first indicators and the second indicator being associated with a difference between the focus parameter peak value of the one first indicator and the current focus value.

7. The photographing device according to claim 6, wherein when the current focus value is equal to the focus parameter peak value corresponding to the one first indicator, the one first indicator and the second indicator overlap with each other.

8. The photographing device according to claim 6, wherein the processor is further configured to execute the program codes to:
obtain a selection operation on a selected first indicator of the plurality of first indicators; and
control the focus adjustment assembly to focus according to the selection operation.

9. The photographing device according to claim 8, wherein the selection operation is a click operation on the selected first indicator.

10. The photographing device according to claim 8, wherein the processor is further configured to execute the program codes to obtain an operation on a selection button, the selection button being configured to select the selected first indicator.

11. The photographing device according to claim 8, wherein the processor is further configured to execute the program codes to control the display assembly to mark at least one focus object of the plurality of focus objects corresponding to the selected first indicator.

12. The photographing device according to claim 1, wherein the focus adjustment assembly includes at least one of a focus ring, an adjustment button, or an adjustment wheel.

13. A control method comprising:
obtaining a current adjustment position of a focus adjustment assembly of a photographing device;
calculating a current focus value corresponding to the current adjustment position of the focus adjustment assembly according to the current adjustment position of the focus adjustment assembly; and
in response to the current focus value being equal to a focus parameter peak value and the focus adjustment assembly continuing to change, controlling the focus adjustment assembly to stop focusing within a preset time period starting from a time at which the current focus value is equal to the focus parameter peak value.

14. The method according to claim 13, further comprising:
calculating the focus parameter peak value corresponding to a focus object in a current image displayed by a display assembly of the photographing device;
controlling the display assembly to display a first indicator wherein the first indicator indicates the focus parameter peak value; and
controlling the display assembly to display a second indicator indicating the current focus value, an indicator distance between the first indicator and the second indicator being associated with a difference between the focus parameter peak value and the current focus value.

15. The method according to claim 14, wherein, when the current focus value is equal to the focus parameter peak value, the first indicator and the second indicator overlap with each other.

16. The method according to claim 15, wherein the first indicator and the second indicator overlap with each other in a user interface displayed by the display assembly within the preset time period.

17. The method according to claim 13, further comprising:
calculating focus parameter peak values respectively corresponding to a plurality of focus objects, respectively, in a current image displayed by the display assembly of the photographing device; and
in response to the current focus value being equal to the focus parameter peak value corresponding to at least one focus object of the plurality of focus objects, controlling the display assembly to mark the at least one focus object.

18. The method according to claim 17, further comprising:
controlling the display assembly to display a plurality of first indicators indicating the focus parameter peak values corresponding to the plurality of focus objects, respectively; and
controlling the display assembly to display a second indicator indicating the current focus value, an indicator distance between one first indicator of the plurality of first indicators and the second indicator being associated with a difference between the focus parameter peak value of the one first indicator and the current focus value.

19. The method according to claim 18, wherein when the current focus value is equal to the focus parameter peak value corresponding to the one first indicator, the one first indicator and the second indicator overlap with each other.

20. The method according to claim 1, wherein the focus adjustment assembly includes at least one of a focus ring, an adjustment button, or an adjustment wheel.
